(19) United States
(12) Patent Application Publication
(10) Pub. No.: US 2008/0066234 A1
(43) Pub. Date: Mar. 20, 2008

(54) "Hug me" pillow

(76) Inventor: Patricia P. Lee, Clayton, NJ (US)

Correspondence Address: Patricia P. Lee, 316 E. Clayton Ave, Clayton, NJ, 08312, US

(21) Appl. No.: 11/706,158

(22) Filed: Mar. 16, 2007

Related U.S. Application Data
(60) Provisional application No. 60/831,596, filed on Sep. 18, 2006.

(51) Int. Cl. A47G 9/00; A61G 7/065

(52) U.S. Cl. 5/636

(57) ABSTRACT

The “HUG ME PILLOW” will be firm as well as have the softness to meet each patient needs. The Interior consist of Beans that are used in beanbags surrounding soft materials similar to sponges and or foam. The front of the pillow will have an angel that say{WE CARE}, the color of the angel will be Black and White. The HUG ME PILLOW will be in the center of the pillow with two arms around the HUG ME PILLOW.

The back ground will be standard colors White,Blue,Red,Yellow,Green and Brown. The edges is square in shape,sizes are small,medium,large and ex-large. Working in this field I have witness patient discomfort after surgery and I know this pillow will help better patient recovery.

I Patricia Lee, claim the “Hug Me Pillow” for those patients who after having surgery have the need of support apply to the surgical area for comfort.

The Hug Me Pillow will be design and come in different sizes to accommodate the surgical area The pillow will be firm as well as have the softness to meet each patient need.

Working in the medical field I have witness patient discomfort after surgery, and I know this product “Hug Me Pillow” will be an asset and play a big role in the patient road to recovery.

1. I Patricia Lee claim the “HUG ME PILLOW” for those patients who after having surgery have the need of support apply to the surgical area for comfort The Hug Me Pillow will be firm as well as have the softness to meet each patient needs.

2. The Pillow will be design and come in different sizes to accommodate the surgical area.

3. The Pillow will be firm as well as have the softness to meet each patient Needs.

4. The Interior of the pillow will consist of beans that are used in bean bags Surrounding soft materials similar to sponges and or foam. The bean bag Will be firm, however at the same time the foam and sponge material will Give the softness for support.

5. The front of the pillow will have an angel that say [WE CARE}, the color Of the angel will be Black and White. The HUG ME PILLOW will be in The center of the pillow like the design submitted, with two arms around The “HUG ME PILLOW” the arms will light brown in color.

6. The background will be standard colors White,Blue,Red,Yellow,Green and Brown. The edges will be square in shape, sizes are small,medium,large And extralarge.

7. Working in the medical field I have witness patient discomfort after Surgery and I know this pillow will help better patient recovery.
